(19) United States
(12) Patent Application Publication
(10) Pub. No.: US 2020/0317879 A1
(43) Pub. Date: Oct. 8, 2020

(54) FIBER-REINFORCEMENT OF FOAM MATERIALS

(71) Applicant: BASF SE, Ludwigshafen am Rhein (DE)

(72) Inventors: Robert Stein, Ludwigshafen am Rhein (DE); Gianpaolo Tomasi, Lemfoerde (DE); Ludwig Windeler, Lemfoerde (DE); Christian Renner, Lemfoerde (DE); Holger Ruckdaeschel, Ludwigshafen am Rhein (DE); Tim Diehlmann, Ludwigshafen am Rhein (DE); Rene Arbter, Ludwigshafen am Rhein (DE); Marc Claude Martin, Lemfoerde (DE)

(21) Appl. No.: 16/303,476

(22) PCT Filed: May 17, 2017
(86) PCT No.: PCT/EP2017/061891

§ 371 Date: Nov. 20, 2018

(51) Int. Cl. C08J 9/00; C08J 9/12; C08J 9/14; C08J 9/36; C08G 18/76; C08G 18/32; C08G 18/65; F03D 3/06; B32B 5/06; B32B 5/18; B32B 5/24; B32B 27/06; B32B 27/12; B32B 7/08; B32B 5/26; B29C 44/56

(52) U.S. Cl. CPC C08J 9/0085; B29K 2105/14; C08J 9/125; C08J 9/141; C08J 9/365; C08G 18/7671; C08G 18/3206; C08G 18/6517; F03D 3/062; B32B 5/06; B32B 5/18; B32B 5/245; B32B 27/065; B32B 27/12; B32B 7/08; B32B 5/26; B29C 44/5663; B29C 44/5681; B29C 44/569; C08J 2203/14; C08J 2203/10; C08J 2203/182; C08J 2375/04; C08J 2205/052; B32B 2250/40; B32B 2260/023; B32B 2260/046; B32B 2262/101; B32B 2307/72; B32B 2603/00; C08J 9/127

(57) ABSTRACT

The present invention relates to a molding made of foam, wherein at least one fiber (F) is located partly within the molding, i.e. is surrounded by the foam. The two ends of the respective fiber (F) not surrounded by the foam thus each project from one side of the molding. The foam is produced by polymerization of a reactive mixture (rM) comprising at least one compound having isocyanate-reactive groups, at least one blowing agent and at least one polyisocyanate.

The present invention relates to a molding made of foam, wherein at least one fiber (F) is located partly within the molding, i.e. is surrounded by the foam. The two ends of the respective fiber (F) not surrounded by the foam thus each project from one side of the molding. The foam is produced by polymerization of a reactive mixture (rM) comprising at least one compound having isocyanate-reactive groups, at least one blowing agent and at least one polyisocyanate.

The present invention further provides a panel comprising at least one such molding and at least one further layer (S1). The present invention further provides processes for producing the moldings of the invention from foam or the panels of the invention and the use thereof, for example as rotor blade in wind turbines.

WO 2006/125561 relates to a process for producing a reinforced cellular material, wherein at least one hole extending from a first surface to a second surface of the cellular material is produced in the cellular material in a first process step. On the other side of the second surface of the cellular material, at least one fiber bundle is provided, said fiber bundle being drawn with a needle through the hole to the first side of the cellular material. However, before the needle takes hold of the fiber bundle, the needle is first pulled through the particular hole coming from the first side of the cellular material. In addition, the fiber bundle, on conclusion of the process according to WO 2006/125561, is arranged partially inside the cellular material, since it fills the corresponding hole, and the corresponding fiber bundle partially projects from the first and second surfaces of the cellular material on the respective sides.

By the process described in WO 2006/125561, it is possible to produce sandwich-like components comprising a core of said cellular material and at least one fiber bundle. Resin layers and fiber-reinforced resin layers may be applied to the surfaces of this core, in order to produce the actual sandwich-like component. Cellular materials used to form the core of the sandwich-like component may, for example, be polyvinyl chlorides or polyurethanes. Examples of useful fiber bundles include carbon fibers, nylon fibers, glass fibers or polyester fibers.

However, WO 2006/125561 does not disclose that foams produced by polymerization of a reactive mixture can be used as cellular material for producing a core in a sandwich-like component. The sandwich-like components according to WO 2006/125561 are suitable for use in aircraft construction.

WO 2011/012587 relates to a further process for producing a core with integrated bridging fibers for panels made of composite materials. The core is produced by pulling the bridging fibers provided on a surface of what is called a “cake” made of lightweight material partially or completely through said cake with the aid of a needle. The “cake” may be formed from polyurethane foams, polyester foams, polyethylene terephthalate foams, polyvinyl chloride foams or a phenolic foam, especially from a polyurethane foam. The fibers used may in principle be any kind of single or multiple threads and other yarns.

The cores thus produced may in turn be part of a panel made of composite materials, wherein the core is surrounded on one or two sides by a resin matrix and combinations of resin matrices with fibers in a sandwich-like configuration. However, WO 2011/012587 does not disclose that foams produced by polymerization of a reactive mixture can be used for producing the corresponding core material.

WO 2012/138445 relates to a process for producing a composite core panel using a multitude of longitudinal strips of a cellular material having a low density. A double-ply fiber mat is introduced between the individual strips, and this brings about adhesive bonding of the individual strips, with use of resin, to form the composite core panels. The cellular material having a low density that forms the longitudinal strips, according to WO 2012/138445, is selected from balsa wood, elastic foams and fiber-reinforced composite foams. The fiber mats introduced in a double-ply arrangement between the individual strips may be a porous glass fiber mat for example. The resin used as adhesive may, for example, be a polyester, an epoxy resin or a phenolic resin, or a heat-activated thermoplastic, for example polypropylene or PET. However, WO 2012/138445 does not disclose that it is also possible to use as the cellular material for the elongated strips a foam produced by polymerization of a reactive mixture. Nor is it disclosed therein that individual fibers or fiber bundles can be introduced into the cellular material for reinforcement. According to WO 2012/138445, exclusively fiber mats that additionally constitute a bonding element in the context of an adhesive bonding of the individual strips by means of resin to obtain the core material are used for this purpose.

GB-A 2 455 044 discloses a process for producing a multilayer composite article, wherein, in a first process step, a multitude of pellets made of thermoplastic material and a blowing agent are provided. The thermoplastic material is a mixture of polystyrene (PS) and polyphenylene oxide (PPO) comprising at least 20% to 70% by weight of PPO. In a second process step the pellets are expanded, and in a third step they are welded in a mold to form a closed-cell foam of the thermoplastic material to give a molding, the closed-cell foam assuming the shape of the mold. In the next process step, a layer of fiber-reinforced material is applied to the surface of the closed-cell foam, the bonding of the respective surfaces being conducted using an epoxy resin. However, GB-A 2 455 044 does not disclose that a fiber material can be introduced into the core of the multilayer composite article.

An analogous process and an analogous multilayer composite article (to those in GB-A 2 455 044) is also disclosed in WO 2009/047483. These multilayer composite articles are suitable, for example, for use as rotor blades (in wind turbines) or as ships' hulls.

U.S. Pat. No. 7,201,625 discloses a process for producing foam products and the foam products per se, which can be used, for example, in the sports sector as a surfboard. The core of the foam product is formed by a particle foam, for example based on a polystyrene foam. This particle foam is produced in a special mold, with an outer plastic skin surrounding the particle foam. The outer plastic skin may, for example, be a polyethylene film. However, U.S. Pat. No. 7,201,625 also does not disclose that fibers for reinforcement of the material may be present in the particle foam.

U.S. Pat. No. 6,767,623 discloses sandwich panels having a core layer of polypropylene particle foam based on particles having a particle size in the range from 2 to 8 mm and a bulk density in the range from 10 to 100 g/l. In addition, the sandwich panels comprise two outer layers of fiber-reinforced polypropylene, with the individual outer layers being arranged around the core so as to form a sandwich. Still further layers may optionally be present in the sandwich panels for decorative purposes. The outer layers may comprise glass fibers or other polymer fibers.

EP-A 2 420 531 discloses extruded foams based on a polymer such as polystyrene comprising at least one mineral filler having a particle size of ≤10 μm and at least one nucleating agent. These extruded foams feature improved stiffness. Additionally described is a corresponding extrusion process for producing such extruded foams based on polystyrene. The extruded foams may be closed-cell foams. However, EP-A 2 480 531 does not state that the extruded foams comprise fibers.

WO 2005/056653 relates to particle foam moldings made of expandable, filler-comprising polymer granulates. The particle foam moldings are obtainable by welding prefoamed foam particles made of expandable, filler-comprising thermoplastic polymer granulates, the particle foam having a density in the range from 8 to 300 g/l. The thermoplastic polymer granulates are in particular a styrene polymer. The fillers used may be pulverulent inorganic substances, metal, chalk, aluminum hydroxide, calcium carbonate or alumina, or inorganic substances in the form of beads or fibers, such as glass beads, glass fibers or carbon fibers.

U.S. Pat. No. 3,030,256 describes laminated panels and a process for the production thereof. The panels comprise a core material into which fiber bundles are introduced and surface materials. The core materials are foamed plastic and expanded plastic. The fibers are located inside the foam with one fiber region. A first fiber region projects from the first side of the molding and a second fiber region projects from the second side of the molding.

U.S. Pat. No. 6,187,411 relates to reinforced sandwich panels which comprise a foam core material that comprises a fiber layer on both sides and fibers that are stitched through the outer fiber layers and the foam. Described foam core materials include polyurethanes, phenols and isocyanates. A foam produced by polymerization of a reactive mixture is not disclosed.

US 2010/0196652 relates to quasi-isotropic sandwich structures comprising a core material surrounded by fiber mats, wherein glass fiber rovings are stitched into the fiber mats and the core material. Foams described include various foams such as for example polyurethane, polyisocyanurate, phenols, polystyrene, PEI, polyethylene, polypropylene and the like.

The disadvantage of the composite materials described in U.S. Pat. Nos. 3,030,256, 6,187,411 and US 2010/0196652 is that these often exhibit insufficient resistance to fracture and relatively high abrasion.

The present invention has for its object to provide novel fiber-reinforced moldings/panels.

This object is achieved in accordance with the invention by a molding made of foam, wherein at least one fiber (F) is with a fiber region (FB2) located inside the molding and surrounded by the foam while a fiber region (FB1) of the fiber (F) projects from a first side of the molding and a fiber region (FB3) of the fiber (F) projects from a second side of the molding, wherein the foam has been produced by polymerization of a reactive mixture (rM) which comprises the following components (A) to (C):
(A) at least one compound having isocyanate-reactive groups, wherein at least one compound having isocyanate-reactive groups has a weight-average molecular weight of at least 1700 g/mol,
(B) at least one blowing agent and
(C) at least one polyisocyanate which comprises 14% to 100% by weight based on the total weight of the at least one polyisocyanate of at least one polyisocyanate prepolymer.

In other words the foam is obtainable by polymerization of the reactive mixture (rM).

It is an advantage of the moldings according to the invention that the use of foams that have been produced by polymerization of the reactive mixture (rM) markedly reduces the abrasion of the foams with respect to rough surfaces and with respect to themselves. This results in lower emission during mechanical processing of the foams and the moldings produced therefrom. In addition the low emission and thus the low abrasion makes it possible to better ensure dimensional stability of converted foams and thus also of the moldings according to the invention.

The foams according to the invention further exhibit better resistance toward fracture, particularly upon vibratory stress, which significantly improves the transportability of the foams and thus also of the moldings according to the invention. In addition the inventive moldings made of foam exhibit improved pullout resistance of the introduced fiber (F).

The foams according to the invention and thus also the moldings according to the invention further feature a high closed-cell content.

In addition the moldings according to the invention advantageously feature a low resin absorption coupled with good interfacial bonding, wherein the low resin absorption is attributable in particular to the foam produced by polymerization of the reactant mixture (rM).

This effect is important especially when the moldings according to the invention are subjected to further processing to afford the panels according to the invention.

A further improvement in bonding coupled with reduced resin absorption is made possible in accordance with the invention by the fiber reinforcement of the foams in the moldings according to the invention or the panels that result therefrom. According to the invention, the fibers (individually or preferably in the form of fiber bundles) may advantageously be introduced into the foam initially in a dry state and/or by mechanical processes. The fibers/fiber bundles are laid down on the respective foam surfaces not flush, but with an overhang, and thus enable an improved bonding/a direct joining with the corresponding outer plies in the panel according to the invention. This is the case in particular when as an outer ply according to the invention at least one further layer (S1) is applied to the moldings according to the invention to form a panel. It is preferable when two layers (S1) which may be identical or different are applied. It is particularly preferable when two identical layers (S1), in particular two identical fiber-reinforced resin layers, are applied to opposite sides of the molding according to the the invention to form a panel according to the invention. Such panels are also referred to as “sandwich materials” and the molding according to the invention may also be referred to as “core material”.

The panels according to the invention thus feature a low resin absorption in conjunction with a good peel strength and a good shear strength and a high shear modulus. Moreover, high strength and stiffness properties can be specifically adjusted through the choice of fiber types and the proportion and arrangement thereof. The effect of low resin absorption is important because a common aim in the use of such panels (sandwich materials) is that the structural properties are to be increased while attaining the lowest possible weight. When using for example fiber-reinforced outer plies not only the actual outer plies and the molding (sandwich core) but also the resin absorption of the molding (core material) contributes to the total weight. However, the moldings according to the invention/the panels according to the invention can reduce resin absorption, thus allowing weight and cost savings.

In addition, further layers (S2) may be applied to the foam during or after manufacture. Such layers improve the overall integrity of the foam/of the molding according to the invention.

Further improvements/advantages can be achieved when the fibers (F) are introduced into the foam at an angle α in the range from 0° to 60° in relation to the thickness direction (d) of the foam, particularly preferably of 0° to 45°. Generally, introduction of the fibers (F) at an angle α of 0° to <90 is performable industrially in automated fashion.

Additional improvements/advantages can be achieved when the fibers (F) are introduced into the foam not only parallel to one another but further fibers (F) are also introduced at an angle β to one another which is preferably in the range from >0 to 180°. This additionally achieves a specific improvement in the mechanical properties of the molding of the invention in different directions.

It is likewise advantageous when in the panels according to the invention the resin (outer) layer is applied by liquid injection methods or liquid infusion methods in which the fibers can be impregnated with resin during processing and the mechanical properties improved. This can additionally result in cost savings.

The present invention is further specified hereinbelow.

According to the invention, the molding comprises a foam and at least one fiber (F).

The foam is produced by polymerization of a reactive mixture (rM) which comprises the following components (A) to (C):
(A) at least one compound having isocyanate-reactive groups, wherein at least one compound having isocyanate-reactive groups has a weight-average molecular weight of at least 1700 g/mol,
(B) at least one blowing agent and
(C) at least one polyisocyanate which comprises 14% to 100% by weight based on the total weight of the at least one polyisocyanate of at least one polyisocyanate prepolymer.

In the context of the present invention the terms “component (A)” and “at least one compound having isocyanate-reactive groups” are used synonymously and therefore have the same meaning.

The same applies to the terms “component (B)” and “at least one blowing agent”. These terms are likewise used synonymously in the context of the present invention and therefore have the same meaning.

In the context of the present invention the terms “component (C)” and “at least one polyisocyanate” are likewise used synonymously and therefore have the same meaning.

The reactive mixture (rM) comprises for example in the range from 25% to 60% by weight of the component (A), preferably in the range from 30% to 50% by weight and especially preferably in the range from 30% to 40% by weight, in each case based on the sum of the weight percentages of the components (A) to (C), preferably based on the total weight of the reactive mixture (rM).

The reactive mixture (rM) comprises for example in the range from 0.5% to 15% by weight of the component (B), preferably in the range from 1% to 12% by weight and especially preferably in the range from 1% to 10% by weight, in each case based on the sum of the weight percentages of the components (A) to (C), preferably based on the total weight of the reactive mixture (rM).

The reactive mixture (rM) comprises for example in the range from 40% to 74.5% by weight of the component (C), preferably in the range from 50% to 69% by weight and especially preferably in the range from 60% to 69% by weight, in each case based on the sum of the weight percentages of the components (A) to (C), preferably based on the total weight of the reactive mixture (rM).

In the context of the present invention “at least one compound having isocyanate-reactive groups” is to be understood as meaning either precisely one compound having isocyanate-reactive groups or a mixture of two or more compounds having isocyanate-reactive groups.

Mixtures of two or three compounds having isocyanate-reactive groups are preferred and mixtures of three compounds having isocyanate-reactive groups are especially preferred.

The term “having isocyanate-reactive groups” is to be understood as meaning that the component (A) comprises at least one, preferably two or more, isocyanate-reactive groups.

Suitable as component (A) are any compounds having isocyanate-reactive groups that are known to those skilled in the art, wherein at least one of these compounds has a weight-average molecular weight of at least 1700 g/mol.

Isocyanate-reactive groups are functional groups which can undergo an addition reaction with isocyanates and are known per se to those skilled in the art, for example OH-groups, SH-groups, NH-groups and/or NH₂-groups.

The component (A) is thus for example selected from the group consisting of polyols and polyamines. Suitable polyols are known to those skilled in the art and are preferably polyester polyols and/or polyether polyols.

It is therefore preferable when the component (A) is selected from the group consisting of polyester polyols, polyether polyols and polyamines. Particularly preferred as component (A) are polyester polyols and polyether polyols. Polyether polyols are most preferred.

According to the invention at least one of the compounds having isocyanate-reactive groups has a weight-average molecular weight of at least 1700 g/mol, preferably of at least 2500 g/mol, particularly preferably of at least 4000 g/mol, for example of 4350 g/mol. The weight-average molecular weight of the component (A) is typically not more than 8000 g/mol, preferably not more than 7000 g/mol and particularly preferably not more than 6000 g/mol. The weight-average molecular weight is determined according to DIN 55672-1:2008.

The functionality of the component (A) is generally in the range from 1.5 to 8, preferably in the range from 1.7 to 7 and particularly preferably in the range from 1.9 to 6.

In the context of the present invention the functionality of the component (A) is to be understood as meaning the average number of isocyanate-reactive groups per molecule. The determination thereof is known to those skilled in the art.

When the component (A) is selected from the group consisting of polyester polyols and polyether polyols the component (A) preferably has a hydroxyl number (OH number) which is greater than 10 mg KOH/g, preferably greater than 15 mg KOH/g, particularly preferably greater than 20 mg KOH/g. The upper limit for the hydroxyl number of the component (A) is typically 1000 mg KOH/g, preferably 900 mg KOH/g and particularly preferably 700 mg KOH/g.

In the context of the present invention the hydroxyl number (OH number) is determined according to DIN 53240-2:2007.

In the case where a mixture of two or more compounds having isocyanate-reactive groups is employed as component (A) the hydroxyl number relates to this mixture. Therefore, it is possible for example that when a mixture of two or more compounds having isocyanate-reactive groups is employed as component (A) one of the compounds has a higher hydroxyl number than the above-described hydroxyl number and another of the compounds has a lower hydroxyl number than the above-described hydroxyl number. Averaged over all hydroxyl numbers the mixture of two or more compounds having isocyanate-reactive groups then has the above-described hydroxyl number. In particular such a mixture of two or more compounds having isocyanate-reactive groups as component (A) has a hydroxyl number in the range from 10 to 80 mg KOH/g, preferably in the range from 15 to 60 mg KOH/g.

Most preferred as component (A) are polyether polyols. Suitable as polyether polyols are any polyether polyols known to those skilled in the art that are producible by any process known to those skilled in the art.

Polyether polyols are typically produced by polymerization of one or more alkylene oxides, preferably having 2 to 4 carbon atoms. The polymerization may for example be an anionic polymerization employing as catalyst alkali metal hydroxides such as sodium hydroxide or potassium hydroxide or alkali metal alkoxides, such as sodium methoxide, sodium ethoxide, potassium ethoxide or potassium isopropoxide, with addition of at least one starter molecule comprising 2 to 8, preferably 3 to 8, hydrogen atoms reactive toward the catalyst. Likewise possible is a cationic polymerization employing as catalyst for example Lewis acids, such as antimony pentachloride, boron fluoride etherate or fuller's earth.

Suitable alkylene oxides having 2 to 4 carbon atoms which are typically polymerized to produce the polyether polyols most preferred as component (A) are for example tetrahydrofuran, 1,3-propylene oxide, 1,2-butylene oxide, 2,3-butylene oxide, styrene oxide, ethylene oxide and/or 1,2-propylene oxide. Ethylene oxide and/or 1,2-propylene oxide are preferred. It is possible according to the invention to employ one of these abovementioned alkylene oxides and it is likewise possible to employ two or more of these alkylene oxides in alternating sequence or as a mixture.

Suitable as the starter molecule preferably employed in the anionic polymerization are any compounds known to those skilled in the art that may be employed as a starter molecule in the anionic polymerization of alkylene oxides.

The starter molecule is preferably selected from the group consisting of alcohols, saccharides, sugar alcohols and amines.

It is therefore preferable when the component (A) is produced from a compound selected from the group consisting of alcohols, saccharides, sugar alcohols and amines.

It is further preferable when the component (A) is produced from one or more alkylene oxides and a starter molecule selected from the group consisting of alcohols, saccharides, sugar alcohols and amines.

Alcohols suitable as starter molecules are for example selected from the group consisting of glycerol, trimethylolpropane (TMP), pentaerythritol and diethylene glycol.

Suitable saccharides are for example saccharose and suitable sugar alcohols are for example sorbitol.

Suitable amines are for example methylamine, ethylamine, isopropylamine, butylamine, benzylamine, aniline, toluidine, tolylenediamine (TDA), naphtyleneamine, ethylendiamine (EDA), diethylenetriamine, 4,4′-methylenedianiline, 1,3-propanediamine, 1,6-hexanediamine, ethanolamine, diethanolamine and/or triethanolamine.

Additionally employable as starter molecules are condensation products of at least one amine, at least one aromatic compound and formaldehyde. Employable are in particular condensation products of formaldehyde, phenol and diethanolamine or ethanolamine, of formaldehyde, alkylphenols and diethanolamine or ethanolamine, of formaldehyde, bisphenol A and diethanolamine or ethanolamine, of formaldehyde, aniline and diethanolamine or ethanolamine, of formaldehyde, cresol and diethanolamine or ethanolamine, of formaldehyde, toluidine and diethanolamine or ethanolamine, of formaldehyde, tolylenediamine (TDA) and diethanolamine or ethanolamine.

Compounds particularly preferred as starter molecules are selected from the group consisting of glycerol, tolylenediamine (TDA), saccharose, pentaerythritol, diethylene glycol, trimethylolpropane (TMP), ethylenediamine, sorbitol and mixtures thereof.

The component (A) is thus preferably produced starting from an alkylene oxide, preferably having 2 to 4 carbon atoms, and at least one starter molecule selected from the group consisting of glycerol, tolylenediamine (TDA), saccharose, pentaerythritol, diethylene glycol, trimethylolpropane (TMP), ethylenediamine, sorbitol and mixtures thereof.

Preferably employed as component (A) according to the invention is a mixture of two or more compounds having isocyanate-reactive groups, particularly preferably a mixture of two or three compounds having isocyanate-reactive groups and very particularly preferably a mixture of precisely three compounds having isocyanate-reactive groups.

The component (A) is thus preferably a mixture of the following components (A1) and (A2):
(A1) at least one polyether polyol based on at least one trivalent alcohol, preferably based on glycerol,
(A2) at least one polyether polyol based on at least one amine, preferably based on tolylenediamine (TDA).

In a further preferred embodiment the component (A) employed is a mixture of the following components (A1) to (A3).
(A1) at least one polyether polyol based on at least one trivalent alcohol, preferably based on glycerol, and
(A2) at least one polyether polyol based on at least one amine, preferably based on tolylenediamine (TDA), and
(A3) at least one polyether polyol based on saccharides and/or alcohols, preferably based on a mixture of saccharose, pentaerythritol and diethylene glycol.

When the at least one polyether polyol of the component (A1) is based on at least one trivalent alcohol, preferably on glycerol, this means that the starter molecule typically employed in the production of the component (A1) is at least a trivalent alcohol, preferably glycerol.

The component (A1) is then for example produced from the starter molecule, at least one trivalent alcohol, preferably from glycerol, and at least one alkylene oxide, preferably propylene oxide and/or ethylene oxide, more preferably a mixture of propylene oxide and ethylene oxide.

In the production of the component (A1) from the starter molecule and at least one alkylene oxide the starter molecule is typically alkoxylated. This process is known to those skilled in the art.

The component (A1) preferably has a weight-average molecular weight of at least 1700 g/mol. For example the weight-average molecular weight of the component (A1) is in the range from 1700 g/mol to 8000 g/mol, preferably in the range from 2500 g/mol to 7000 g/mol, especially preferably in the range from 3000 g/mol to 6000 g/mol, for example 4350 g/mol, determined according to DIN 55672-1:2008.

The hydroxyl number (OH number) of the component (A1) is for example in the range from to 80 mg KOH/g, preferably in the range from 15 to 60 mg KOH/g, particularly preferably in the range from 25 to 45 mg KOH/g The abovementioned elucidations and preferences apply to the determination of the hydroxyl number.

The functionality of the component (A1) is for example in the range from 1.5 to 6, preferably in the range from 1.7 to 5 and particularly preferably in the range from 1.9 to 4.5.

When the at least one polyether polyol of component (A2) is based on at least one amine, preferably on tolylenediamine (TDA), this means that the starter molecule typically employed in the production of the component (A2) is at least one amine, preferably tolylenediamine (TDA).

The component (A2) is then for example produced from the starter molecule, at least one amine, preferably from tolylenediamine (TDA), and at least one alkylene oxide, preferably propylene oxide and/or ethylene oxide, more preferably a mixture of propylene oxide and ethylene oxide.

In the production of the component (A2) from the starter molecule and at least one alkylene oxide the starter molecule is typically alkoxylated. This process is known to those skilled in the art.

The weight-average molecular weight of the component (A2) is for example in the range from 200 g/mol to 2000 g/mol, preferably in the range from 250 g/mol to 1500 g/mol and preferably in the range from 300 g/mol to 1000 g/mol, for example 530 g/mol, determined according to DIN 55672-1:2008.

The component (A2) has for example a hydroxyl number (OH number) in the range from 100 to 600 mg KOH/g, preferably in the range from 120 to 500 mg KOH/g, particularly preferably in the range from 150 to 450 mg KOH/g.

The functionality of the component (A2) is for example in the range from 2 to 5, preferably in the range from 2.5 to 4.5 and particularly preferably in the range from 3 to 4.2.

When the at least one polyether polyol of the component (A3) is based on saccharides and/or alcohols, preferably on a mixture of saccharose, pentaerythritol and diethylene glycol, this means that the starter molecule typically employed in the production of the component (A3) is a saccharide and/or an alcohol, preferably a mixture of saccharose, pentaerythritol and diethylene glycol.

The component (A3) is then for example produced from the starter molecule, a saccharide and/or an alcohol, preferably from a mixture of saccharose, pentaerythritol and diethylene glycol, and at least one alkylene oxide, preferably propylene oxide and/or ethylene oxide, more preferably propylene oxide.

In the production of the component (A3) from the starter molecule and at least one alkylene oxide the starter molecule is typically alkoxylated. This process is known to those skilled in the art.

The component (A3) has for example a weight-average molecular weight in the range from 200 g/mol to 2000 g/mol, preferably in the range from 300 g/mol to 1500 g/mol, particularly preferably in the range from 400 g/mol to 1000 g/mol, for example of 545 g/mol, determined by means of DIN 55672-1:2008.

The hydroxyl number (OH number) of the component (A3) is for example in the range from 100 to 600 mg KOH/g, preferably in the range from 200 to 500 mg KOH/g and particularly preferably in the range from 300 to 450 mg KOH/g.

The functionality of the component (A3) is for example in the range from 2 to 6, preferably in the range from 2.5 to 5.5 and particularly preferably in the range from 3 to 5.2.

When the component (A) employed is a mixture of the components (A1) to (A3) the components (A1) to (A3) may be employed in any desired amounts.

It is then preferable to employ in the range from 30% to 60% by weight, preferably in the range from 35% to 50% by weight, particularly preferably in the range from 38% to 45% by weight, of the component (A1) in each case based on the sum of the percentages by weight of the components (A1), (A2) and (A3), particularly preferably based on the total weight of the component (A).

Then employed are for example in the range from 10% to 40% by weight of the component (A2), preferably in the range from 20% to 40% by weight of the component (A2) and particularly preferably in the range from 25% to 35% by weight of the component (A2), in each case based on the sum of the percentages by weight of the components (A), (A2) and (A3), preferably based on the total weight of the component (A).

It is then also preferable to employ in the range from 10% to 40% by weight of the component (A3), particularly preferably in the range from 20% to 40% by weight and especially preferably in the range from 22% to 35% by weight, in each case based on the sum of the percentages by weight of the components (A), (A2) and (A3), preferably based on the total weight of the component (A).

The sum of the percentages by weight of the components (A1), (A2) and (A3) typically sum to 100%.

As component (B) the reactive mixture (rM) comprises at least one blowing agent.

In the context of the present invention “at least one blowing agent” is to be understood as meaning either precisely one blowing agent or else a mixture of two or more blowing agents.

Employable blowing agents are chemical and/or physical blowing agents.

In the context of the present invention the chemical blowing agents are to be understood as meaning blowing agents that are initially present in the reactive mixture (rM) in solid or liquid form and then react by chemical reaction with the components (A) and/or (C) and optionally with further components present in the reactive mixture (rM) to form gaseous products which then serve as the actual blowing agent. In the context of the present invention physical blowing agents are to be understood as meaning blowing agents that have been dissolved or emulsified in the reactive mixture (rM) optionally under pressure and that vaporize under the conditions of polymerization of the reactive mixture (rM).

Suitable chemical and physical blowing agents are known per se to those skilled in the art.

Chemical blowing agents include for example water and carboxylic acids, in particular formic acid.

Physical blowing agents include for example hydrocarbons, in particular (cyclo)aliphatic hydrocarbons, halogenated hydrocarbons, such as perfluorinated alkanes, pentafluorohexane, fluorochlorohydrocarbons, ether ester ketones and acetals and also inorganic and organic compounds which release nitrogen upon heating. Likewise employable are mixtures of the recited physical blowing agents, for example of (cyclo)aliphatic hydrocarbons having 4 to 8 carbon atoms or of fluorohydrocarbons, such as 1,1,1,3,3-pentafluoropropane (HFC 245 fa), trifluoromethane, difluoromethane, 1,1,1,3,3-pentafluorobutane (HFC 365 mfc), 1,1,1,2-tetrafluoroethane, difluoroethane and heptafluoropropane. Combinations with chemical blowing agents are also possible.

Preferred (cyclo)aliphatic hydrocarbons having 4 to 8 carbon atoms are for example n-pentane, isopentane and cyclopentane.

It is preferable when the component (B) of the reactive mixture (rM) is selected from the group consisting of n-pentane, isopentane, cyclopentane, 1,1,1,3,3-pentafluorobutane, 1,1,1,3,3-pentafluoropropane, 1,1,1,2,3,3,3-heptafluoropropane, water, formic acid and hydrofluoroolefins, such as 1,1,1,4,4,4 hexafluoro-2-butene and 1-chloro-3,3,3-trifluoropropene.

As component (C) the reactive mixture (rM) comprises at least one polyisocyanate which comprises 14% to 100% by weight based on the total weight of the at least one polyisocyanate of at least one polyisocyanate prepolymer.

The sum of the percentages by weight of the at least one polyisocyanate and of the at least one polyisocyanate prepolymer is typically 100% by weight.

It will be appreciated that when the component (C) comprises 100% by weight of the at least one polyisocyanate prepolymer the at least one polyisocyanate prepolymer then corresponds to the component (C). In this case the terms “component (C)” and “at least one polyisocyanate prepolymer” are thus used synonymously and then have the same meaning.

In the context of the present invention a “polyisocyanate” is to be understood as meaning an organic compound having at least one isocyanate group, preferably two or more isocyanate groups. Organic compounds having precisely two isocyanate groups are also referred to as diisocyanates.

Suitable as component (C) are for example aliphatic, cycloaliphatic and/or aromatic polyisocyanates. Aromatic polyisocyanates are preferred.

Suitable aliphatic polyisocyanates are for example hexamethylene 1,6-diisocyanate 2-methylpentamethylene 1,5-diisocyanate, 2-ethylbutylene 1,4-diisocyanate, pentamethylene 1,5-diisocyanate and butylene 1,4-diisocyanate and also mixtures thereof.

Suitable cycloaliphatic polyisocyanates are for example 1-isocyanato-3,3,5-trimethyl-5-isocyanatomethylcyclohexane (isophorone diisocyanate), 1,4-cyclohexane diisocyanate, 1-methyl-2,4-cyclohexane diisocyanate, 1-methyl-2,6-cyclohexane diisocyanate, 4,4′-dicyclohexylmethane diisocyanate, 2,4′-dicyclohexylmethane diisocyanate, 2,2′-dicyclohexylmethane diisocyanate and the corresponding isomer mixtures.

Suitable as aromatic polyisocyanates are for example 1,5-naphthylene diisocyanate (1,5-NDI), 2,4- and 2,6-tolylene diisocyanate (TDI) and mixtures thereof, 2,4′-, 2,2′- or 4,4′-diphenylmethane diisocyanate (mMDI) and also mixtures thereof, polyphenyl polymethylene polyisocyanate (polymer MDI, pMDI), mixtures of 2,4′-, 2,2′- and 4,4′-diphenylmethane diisocyanate and polyphenyl polymethylene polyisocyanates (crude MDI), mixtures of crude MDI and tolylene diisocyanates, polyphenyl polyisocyanates, carbodiimide-modified liquid 4,4′- and/or 2,4-diphenylmethane diisocyanates and 4,4′-diisocyanato-(1,2)-diphenylethane.

Preferred as component (C) are in particular polyisocyanates liquid at a temperature of 25° C.

According to the invention the component (C) comprises 14% to 100% by weight of a polyisocyanate prepolymer. It is preferable when the component (C) comprises 30% to 100% by weight, particularly preferably 50% to 100% by weight, of the polyisocyanate prepolymer, wherein the percentages by weight are in each case based on the total weight of the component (C).

In a further embodiment the component (C) comprises 11% to 39.5% by weight, preferably 12% to 35% by weight, particularly preferably 12.5% to 33% by weight, of the polyisocyanate prepolymer in each case based on the total weight of the component (C).

The functionality of the preferably employed polyisocyanate prepolymers is typically in the range from 1 to 4, preferably in the range from 2 to 3.

The functionality of the component (C) is to be understood as meaning the average number of isocyanate groups per molecule. The determination thereof is known to those skilled in the art.

Polyisocyanate prepolymers per se are known to those skilled in the art. The production of polyisocyanate prepolymers is typically effected by reacting the above-described polyisocyanates with compounds having isocyanate-reactive groups, preferably with polyols, at temperatures of about 80° C. to afford polyisocyanate prepolymers. The compounds having isocyanate-reactive groups and the polyisocyanates are preferably employed in a ratio such that the isocyanate content (NCO content) of the polyisocyanate prepolymer is in the range from 8% to 35%, preferably in the range from 15% to 30% and especially preferably in the range from 20% to 30%.

Suitable as compounds having isocyanate-reactive groups are the polyester polyols and polyether polyols described hereinabove for the components (A). Polyether polyols are preferred and polyether polyols having a hydroxyl number (OH number) of at least 100 mg KOH/g are especially preferred. The hydroxyl number of the polyether polyols preferably used for producing the polyisocyanate prepolymer is preferably in the range from 100 to 600 mg KOH/g, particularly preferably in the range from 150 to 500 mg KOH/g and especially preferably in the range from 200 to 450 mg KOH/g.

The functionality of the polyether polyols preferably used for producing the polyisocyanate prepolymer is for example in the range from 1.5 to 6, preferably in the range from 1.7 to 5 and especially preferably in the range from 1.9 to 4.5.

The polyether polyols preferably used for producing the polyisocyanate prepolymer may be produced by any methods known to those skilled in the art. It is preferable when they are produced as described hereinabove for the component (A), wherein as the starter molecule it is especially preferable to employ glycerol which is then reacted with ethylene oxide and/or propylene oxide. It is particularly preferable when the polyether polyol is produced from dipropylene glycol and/or from polypropylene glycol.

It is particularly preferable when the component (C) is a polyisocyanate prepolymer produced from 4,4′-diphenylmethane diisocyanate, dipropylene glycol and propylene glycol.

In a further preferred embodiment the component (C) is a polyisocyanate prepolymer of 4,4′-diphenylmethane diisocyanate, polyphenyl polymethylene polyisocyanate and polypropylene glycol.

In a further preferred embodiment as component (C) at least one of the two above-described polyisocyanate prepolymers is employed with further polyisocyanates. Preferred as these further polyisocyanates is a mixture of 4,4′-diphenylmethane diisocyanate with higher-functional oligomers and isomers.

In a further preferred embodiment the component (C) is a polyisocyanate prepolymer of pMDI, a mixture of 4,4′-diphenylmethane diisocyanate with higher-functional oligomers and isomers having an isocyanate content of 31.5% and a polyether polyol composed of trimethylopropane (TMP) and ethylene oxide (EO), wherein the isocyanate prepolymer has an isocyanate content of 26.8% and the TMP-EO polyether has an OH number of 250 mg KOH/g.

It is preferable when the component (C) has an isocyanate index in the range from 90 to 180, preferably in the range from 80 to 150.

In the context of the present invention the isocyanate index is to be understood as meaning the stoichiometric ratio of isocyanate groups to isocyanate-reactive groups multiplied by 100. “Isocyanate-reactive groups” are to be understood as meaning all isocyanate-reactive groups present in the reactive mixture (rM) including optionally chemical blowing agents and compounds having epoxide groups but not the isocyanate group itself.

In one embodiment of the present invention preferred according to the invention the reactive (rM) mixture comprises no further polyisocyanate other than component (C).

The reactive mixture (rM) which is polymerized to produce the foam may additionally comprise further components. Typically the reactive (rM) mixture additionally comprises a component (D), at least one catalyst.

In the context of the present invention “at least one catalyst” means either precisely one catalyst or a mixture of two or more catalysts.

In the context of the present invention the terms “component (D)” and “at least one catalyst” are used synonymously and therefore have the same meaning.

Employable as component (D) are all compounds known to those skilled in the art which accelerate the reaction between the component (A) and the component (C). Such compounds are known to those skilled in the art.

Suitable compounds are basic polyurethane catalysts, for example tertiary amines, such as triethylamine, tributylamine, dimethylbenzylamine, dicyclohexylmethylamine, dimethylcyclohexylamine, N,N,N′,N′-tetramethyldiamiriodiethyl ether, bis(dimethylaminopropyl)urea, N-methyl and N-ethylmorpholine, N-cyclohexylmorpholine, N,N,N′,N′-tetramethylethylenediamine, N,N,N,N-tetramethylbutanediamine, N,N,N,N-tetramethylhexanediamine, 1,6-pentamethyldiethylenetriamine, bis(2-dimethylaminoethyl) ether, dimethylpiperazine, N-dimethylaminoethylpiperidine, 1,2-dimethylimidazole, 1-azabicyclo[2.2.0]octane, 1,4-diazabicyclo[2.2.2]octane (Dabco) and alkanolamine compounds, such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, andtriethylenediamine.

Also suitable are metal salts, such as iron(II) chloride, zinc chloride, lead octoate and tin salts, such as tin dioctoate, tin diethylhexoate and dibutyltin dilaurate.

Among the metal salts tin salts are preferred. Particularly preferred as catalyst are mixtures of tertiary amines and organic tin salts.

Also contemplated as catalysts are: amidines, such as 2,3-dimethyl-3,4,5,6-tetrahydropyrimidine, tetraalkylammonium hydroxides such as tetramethylammonium hydroxide, alkali metal hydroxides, such as sodium hydroxide, and alkali metal alkoxides, such as sodium methoxide and potassium isopropoxide, alkali metal carboxylates and also alkali metal salts of long-chain fatty acids having 10 to 20 carbon atoms and optionally lateral OH-groups.

It is preferable to use 0.001 to 10 parts by weight of catalyst/catalyst combination based (i.e. reckoned) on 100 parts by weight of the component (B). It is also possible to perform the reaction without catalysis. In this case the catalytic activity of amine-started polyols is utilized.

When a larger polyisocyanate excess is used in the reactive mixture (rM) contemplated catalysts further include: isocyanurate-forming catalysts, for example ammonium ion salts or alkali metal salts, specifically ammonium or alkali metal carboxylates, alone or in combination with tertiary amines. The isocyanurate formation results in particularly flame retardant PIR foams. These catalysts catalyze in particular the trimerization reaction of NCO groups.

The reactive mixture (rM) may additionally comprise a component (E), additives. Such additives are known to those skilled in the art and include for example stabilizers, interface-active substances, flame retardants and chain extenders.

Stabilizers are also known as foam stabilizers. In the context of the present invention stabilizers are to be understood as meaning substances which promote the formation of a uniform cell structure during formation of the foam. Suitable stabilizers are for example silicone-containing foam stabilizers such as siloxane-oxyalkylene mixed polymers and other organopolysiloxanes, also alkoxylation products of fatty alcohols, oxoalcohols, fatty amines, alkylphenols, dialkylphenols, alkylcresols, alkylresorcinol, naphthol, alkylnaphthol, naphthylamine, aniline, alkylaniline, toluidine, bisphenol A, alkylated bisphenol A, polyvinyl alcohol and further alkoxylation products of condensation products of formaldehyde and alkylphenols, formaldehyde and dialkylphenols, formaldehyde and alkylcresols, formaldehyde and alkylresorcinol, formaldehyde and aniline, formaldehyde and toluidine, formaldehyde and naphthol, formaldehyde and alkylnaphthol and formaldehyde and bisphenol A or mixtures of two or more of these foam stabilizers.

Interface-active substances are also known as surface-active substances. Interface-active substances are to be understood as meaning compounds which serve to promote homogenization of the starting materials and which may also be suitable to regulate the cell structure of the foams. These include for example emulsifiers such as sodium salts of castor oil sulfates or of fatty acids and salts of fatty acids with amines, for example diethylamine oleate, diethanolamine stearate, diethanolamine ricinoleate, salts of sulfonic acids, for example alkali metal or ammonium salts of dodecylbenzene- or dinaphthylmethanedisulfonic acid and ricinoleic acid.

Employable flame retardants are for example organic phosphoric and/or phosphonic esters. It is preferable to employ compounds unreactive toward isocyanate groups. Chlorine-comprising phosphoric esters are also included among the preferred compounds. Suitable flame retardants are for example tris(2-chloropropyl) phosphate, triethyl phosphate, diphenyl cresyl phosphate, diethyl ethanephosphinate, tricresyl phosphate, tris(2-chloroethyl) phosphate, tris(1,3-dichloropropyl) phosphate, tris(2,3-dibromopropyl) phosphate, tetrakis(2-chloroethyl) ethylene diphosphate, dimethyl methanephosphonate, diethyl diethanolaminomethylphosphonate and also commercially available halogenated flame retardant polyols.

Also employable for example are bromine-comprising flame retardants. Preferably employed as bromine-comprising flame retardants are compounds which are reactive toward the isocyanate group. Such compounds are, for example, esters of tetrabromophthalic acid with aliphatic diols and alkoxylation products of dibromobutenediol. Compounds derived from the group of brominated OH-comprising neopentyl compounds may also be employed.

Also employable for making the polyisocyanate polyaddition products flame resistant apart from the abovementioned halogen-substituted phosphates are, for example, inorganic or organic flame retardants such as red phosphorus, aluminum oxide hydrate, antimony trioxide, arsenic oxide, ammonium polyphosphate and calcium sulfate, expandable graphite or cyanuric acid derivatives such as for example melamine or mixtures of two flame retardants such as for example ammonium polyphosphates and melamine and optionally maize starch or ammonium polyphosphate, melamine and expandable graphite and/or optionally aromatic polyesters.

Chain extenders are to be understood as meaning difunctional compounds. Such compounds are known per se to those skilled in the art. Suitable chain extenders are for example aliphatic, cycloaliphatic and/or aromatic diols having two to fourteen, preferably two to ten carbon atoms, such as ethylene glycol, 1,2-propanediol, 1,3-propanediol, 1,2-pentanediol, 1,3-pentanediol, 1,10-decanediol, 1,2-dihydroxycyclohexane, 1,3-dihydroxycyclohexane, 1,4-dihydroxycyclohexane, diethyleneglycol, triethylene glycol, dipropylene glycol, tripropylene glycol, 1,4-butanediol, 1,6-hexanediol and bis(2-hydroxyethyl)hydroquinone.

The percentages by weight of the components (A), (B) and (C) and optionally of the components (D) and (E) present in the reactive mixture (rM) typically sum to 100%.

According to the invention the foam is produced by polymerization of the reactive mixture (rM). The polymerization of the reactive mixture (rM) may be effected by any methods known to those in the art.

Typically, the components (A) to (C) and optionally (D) and (E) are mixed with one another and then polymerized. All components may be mixed with one another simultaneously and it is likewise possible to premix for example two or more of the components (A) to (C) and optionally (D) and (E) and then add the remaining components. This embodiment is preferred. It is especially preferable when the components (A) and (B) and optionally (D) and (E) are premixed and the component (C) is added subsequently to obtain the reactive mixture (rM).

The polymerization of the reactive mixture (rM) may then be effected at any desired temperature. A distinction is typically made between the mixing temperature, the mold temperature and the temperature in the foam during the reaction.

The mixing temperature is the temperature at which the components (A), (B) and (C) and optionally (D) und (E) present in the reactive mixture (rM) are mixed. The polymerization of the reactive mixture (rM) which is exothermic typically already commences during the mixing. This causes the temperature to increase and the temperature in the foam during the reaction is therefore generally higher than the mixing temperature. The mold temperature is the temperature of the mold into which the reactive mixture (rM) is introduced.

It is preferable when the mixing temperature of the reactive mixture (rM) is in the range from 10° C. to 200° C., preferably in the range from 15° C. to 100° C., especially preferably in the range from 20° C. to 80° C. and most preferably in the range from 20° C. to 55° C.

The polymerization may be carried out at any desired pressure.

The reactive mixture (rM) is typically transferred into a region of relatively low pressure during or following its polymerization and thus undergoes foaming to obtain the foam.

Processes for transferring the reactive mixture (rM) into a region of relatively low pressure are known to those skilled in the art and include for example extrusion.

The foam is a polyurethane foam, a polyisocyanurate foam or a polyurea foam, preferably a polyisocyanate foam or a polyurethane foam, most preferably a polyurethane foam.

For example a polyurethane foam is formed when at least one polyether polyol is employed as component (A).

A polyisocyanurate foam is formed for example when the component (C) also reacts with itself, for example due to addition of suitable catalysts, due to an excess of component (C) and/or due to elevated temperatures. At least one polyester polyol is then typically employed as component (A).

A polyurea foam is obtained for example when at least one polyamine is employed as component (A). A polyurea foam is also formed by the reaction of isocyanates (component (C)) with water in-situ.

It will be appreciated that polyurethane foams may also comprise for example isocyanurate units, allophanate units, urea units, carbodiimide units, biuret units, uretonimine units and optionally further units which may form during addition reactions of polyisocyanates and/or which were already present in the component (A) or (C). However, in the case of polyurethane foams the majority of the units formed by reaction of the component (A) with the component (C) are polyurethane units.

Polyisocyanurate foams may likewise also comprise for example urethane units, allophanate units, urea units, carbodiimide units, biuret units, uretonimine units and optionally further units which may form during addition reactions of polyisocyanates and/or which were already present in the components (A) or (C). However, in the case of polyisocyanurate foams the majority of the units formed by reaction of the component (A) with the component (C) are isocyanurate units.

Polyurea foams may likewise also comprise for example urethane units, allophanate units, isocyanurate units, carbodiimide units, biuret units, uretonimine units and optionally further units which may form during addition reactions of polyisocyanates and/or which were already present in the components (A) or (C). However, in the case of polyurea foams the majority of the units formed by reaction of the component (A) with the component (C) are urea units.

The foam produced typically has a glass transition temperature of at least 80° C., preferably of at least 110° C. and especially preferably of at least 130° C. determined by differential scanning calorimetry (DSC). The glass transition temperature of the foam is generally not more than 400° C., preferably not more than 300° C. and especially preferably not more than 200° C., determined by differential scanning calorimetry (DSC).

The foam according to the invention may have any desired dimensions. Based on an orthogonal system of coordinates, the length of the foam is referred to as the x-direction, the width as the y-direction and the thickness as the z-direction.

The foam typically has a thickness (z-direction) in the range of 4 to 2000 mm, preferably in the range from 5 to 1000 mm, especially preferably in the range from 10 to 500 mm, a length (x-direction) of at least 200 mm, preferably of at least 400 mm, and a width (y-direction) of at least 200 mm, preferably of at least 400 mm.

The foam typically has a length (x-direction) of not more than 15 000 mm, preferably of not more than 2500 mm, and/or a width (y-direction) of not more than 4000 mm, preferably of not more than 2500 mm.

In a preferred embodiment the foam produced by polymerization of the reactive mixture (rM) has a sealed (closed) surface having a high surface quality. In the context of the present invention the term “closed surface” is to be understood as meaning the following: The closed surface is evaluated by optical or electron micrographs. By image analyses, the area fraction of open foam cells relative to the total surface area is assessed. Foams having a closed surface are defined as (1−area fraction of open foam cells)/total surface area >30%, preferably >50%, more preferably >80%, especially preferably >95%.

Preference is therefore also given to a molding where the total surface area of the molding is closed to an extent of more than 30%, preferably to an extent of more than 50%, more preferably to an extent of more than 80%, especially preferably to an extent of more than 95%.

It is also preferable when the foam has a closed-cell content of at least 80%, more preferably at least 95%, particularly preferably at least 98%.

The closed-cell content of the foam is determined according to DIN ISO 4590 (as per German version of 2003). The closed-cell content describes the volume fraction of closed cells with respect to the total volume of the foam.

The closed surface is typically a direct consequence of the production of the foam by polymerization of the reactive mixture (rM). This is known to those skilled in the art.

It is likewise preferable when the surface of at least one side of the molding has at least one depression. The depression is preferably a slot or a hole.

According to the invention the molding comprises at least one fiber (F) as well as the foam.

The fiber (F) present in the molding is a single fiber or a fiber bundle, preferably a fiber bundle. Suitable fibers (F) are all materials known to those skilled in the art that can form fibers. The fiber (F) is for example an organic, inorganic, metallic or ceramic fiber or a combination thereof, preferably a polymeric fiber, basalt fiber, glass fiber, carbon fiber or natural fiber, especially preferably a polyaramid fiber, glass fiber, basalt fiber or carbon fiber; a polymeric fiber is preferably a fiber of polyester, polyamide, polyaramid, polyethylene, polyurethane, polyvinyl chloride, polyimide and/or polyamide imide; a natural fiber is preferably a fiber of sisal, hemp, flax, bamboo, coconut and/or jute.

In one embodiment, fiber bundles are used. The fiber bundles are composed of a plurality of single fibers (filaments). The number of individual fibers per bundle is at least 10, preferably 100 to 100 000, particularly preferably 300 to 10 000, in the case of glass fibers and 1000 to 50 000 in the case of carbon fibers and especially preferably 500 to 5000 in the case of glass fibers and 2000 to 20 000 in the case of carbon fibers.

According to the invention, the at least one fiber (F) is with a fiber region (FB2) located inside the molding and is surrounded by the extruded foam, while a fiber region (FB1) of the fiber (F) projects from a first side of the molding and a fiber region (FB3) of the fiber (F) projects from a second side of the molding.

The fiber region (FB1), the fiber region (FB2) and the fiber region (FB3) may each account for any desired proportion of the total length of the fiber (F). In one embodiment the fiber region (FB1) and the fiber region (FB3) each independently of one another account for 1% to 45%, preferably 2% to 40% and particularly preferably 5% to 30% and the fiber region (FB2) accounts for 10% to 98%, preferably 20% to 96%, particularly preferably 40% to 90%, of the total length of the fiber (F).

In a further preferred embodiment, the first side of the molding from which the fiber region (FB1) of the fiber (F) projects is opposite the second side of the molding from which the fiber region (FB3) of the fiber (F) projects.

The fiber (F) has preferably been introduced into the molding at an angle α relative to the thickness direction (d) of the molding/to the orthogonal (of the surface) of the first side (2) of the molding. The angle α may assume any desired values from 0° to 90°. For example the fiber (F) has been introduced into the reactive foam at an angle α of 0° to 60°, preferably of 0° to 50°, more preferably of 0° to 15° or of 10° to 70°, preferably of 30° to 60°, particularly preferably of 30° to 50°, yet more preferably of 30° to 45°, in particular of 45°, relative to the thickness direction (d) of the molding.

In a further embodiment at least two fibers (F) are introduced at two different angles α, α₁ and α₂, wherein the angle α₁ is preferably in the range from 0° to 15° and the second angle α₂ is preferably in the range from 30° to 50°; especially preferably α₁ is in the range from 0° to 5° and α₂ is in the range from 40° to 50°.

It is preferable when a molding according to the invention comprises a multitude of fibers (F), preferably as fiber bundles, and/or comprises more than 10 fibers (F) or fiber bundles per m², preferably more than 1000 per m², particularly preferably 4000 to 40 000 per m². It is preferable when all fibers (F) in the molding according to the invention have the same angle α or at least approximately the same angle (deviation of not more than +/−5°, preferably +/−2°, particularly preferably +/−1).

All fibers (F) may be arranged parallel to one another in the molding. It is likewise possible and preferable according to the invention that two or more fibers (F) are arranged in the molding at an angle β to one another. In the context of the present invention the angle θ is to be understood as meaning the angle between the orthogonal projection of a first fiber (F1) onto the surface of the first side of the molding and the orthogonal projection of a second fiber (F2) onto the surface of the molding, wherein both fibers have been introduced into the molding.

The angle β is preferably in the range of β=360°/n, wherein n is an integer. It is preferable when n is in the range from 2 to 6, particularly preferably in the range from 2 to 4. The angle β is 90°, 120° or 180° for example. In a further embodiment the angle β is in the range from 800 to 100°, in the range from 110° to 130° or in the range from 170° to 190°. In a further embodiment more than two fibers (F) have been introduced at an angle 1 to one another, for example three or four fibers (F). These three or four fibers (F) may each have two different angles β, 1 and 2 to the two adjacent fibers. It is preferable when all of the fibers (F) have the same angles β=β₁=μ₂ to the two adjacent fibers (F). For example when the angle is 90° then the angle β between the first fiber-(F1) and the second fiber (F2) is 90°, the angle β₂ between the second fiber (F2) and the third fiber (F3) is 90°, the angle β between the third fiber and the fourth fiber (F4) is 90° and the angle β₄ between the fourth fiber (F4) and the first fiber (F1) is likewise 90°. The angles β between the first fiber (F1) (reference) and the second (F2), third (F3) and fourth fiber (F4) are then 90°, 180° and 270° in a clockwise direction. Analogous considerations apply to the other possible angles.

The first fiber (F1) then has a first direction and the second fiber (F2) arranged at an angle β to the first fiber (F1) has a second direction. It is preferable when there is a similar number of fibers in the first direction and in the second direction. “Similar” in the present context is to be understood as meaning that the difference between the number of fibers in each direction relative to the other direction is <30%, particularly preferably <10% and especially preferably <2%.

The fibers or fiber bundles may be introduced in irregular or regular patterns. Preference is given to the introduction of fibers or fiber bundles in regular patterns. “Regular patterns” in the context of the present invention is to be understood as meaning that all fibers are aligned parallel to one another and that at least one fiber or fiber bundle has the same distance (a) from all directly adjacent fibers or fiber bundles. It is especially preferable when all fibers or fiber bundles have the same distance from all directly adjacent fibers or fiber bundles.

In a further preferred embodiment the fibers or fiber bundles are introduced such that based on an orthogonal system of coordinates where the thickness direction (d) corresponds to the z-direction they each have the same distance (aₓ) from one another in the x-direction and the same distance (a_{y}) in the y-direction. It is especially preferable when they have the same distance (a) in the x-direction and in the y-direction, wherein a=aₓ=a_{y}.

When two or more fibers (F) are at an angle R to one another the first fibers (F1) that are parallel to one another preferably have a regular pattern with a first distance (a₁) and the second fibers (F2) that are parallel to one another and are at an angle to the first fibers (F1) preferably have a regular pattern with a second distance (a₂). In a preferred embodiment the first fibers (F1) and the second fibers (F2) each have a regular pattern with a distance (a). In that case, a=a₁=a₂.

If fibers or fiber bundles are introduced into the foam at an angle 1 to one another, it is preferable that the fibers or fiber bundles follow a regular pattern in each direction.

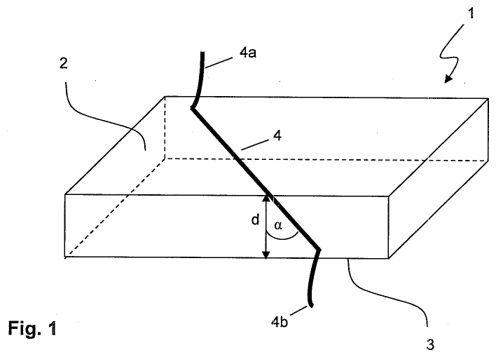

FIG. 1 shows a schematic diagram of a preferred embodiment of the inventive molding made of foam (1) in a perspective view. (2) represents (the surface of) a first side of the molding while (3) represents a second side of the corresponding molding. As is also apparent from FIG. 1, the first side (2) of the molding is opposite the second side (3) of this molding. The fiber (F) is represented by (4). One end of this fiber (4a) and thus the fiber region (FB1) projects from the first side (2) of the molding while the other end (4b) of the fiber which constitutes the fiber region (FB3) projects from the second side (3) of the molding. The middle fiber region (FB2) is located inside the molding and is thus surrounded by the foam.

In FIG. 1, the fiber (4) which is, for example, a single fiber or a fiber bundle, preferably a fiber bundle, is located at an angle α relative to the thickness direction (d) of the molding or to the orthogonal (of the surface) of the first side (2) of the molding. The angle α may assume any desired values from 0° to 90° and is normally 0° to 60°, preferably 0° to 50°, particularly preferably 0° to 15° or 10° to 70°, preferably 30° to 60°, more preferably 30° to 50°, very particularly 30 to 45°, in particular 45°. For clarity, FIG. 1 shows just a single fiber (F).

FIG. 3 shows by way of example a schematic diagram of some of the different angles. The molding made of foam (1) shown in FIG. 3 comprises a first fiber (41) and a second fiber (42). For clarity, in FIG. 3 only the fiber region (FB1) that projects from the first side (2) of the molding is shown for the two fibers (41) and (42). In the context of FIG. 3 the fiber region (FB1) is regarded as an extension of the fiber region (F132) enclosed by the foam. The first fiber (41) forms a first angle α (α1) relative to the orthogonal (O) of the surface of the first side (2) of the molding. The second fiber (42) forms a second angle α (α2) relative to the orthogonal (O) of the surface of the first side (2). The orthogonal projection of the first fiber (41) onto the first side (2) of the molding (41p) forms the angle β with the orthogonal projection of the second fiber (42) onto the first side (2) of the molding (42p).

The present invention also provides a panel comprising at least one molding according to the invention and at least one layer (S1).

A “panel” may optionally also be referred to among specialists in the art as a “sandwich”, “sandwich material”, “laminate” and/or “composite article”.

In a preferred embodiment of the panel the panel comprises two layers (S1) and the two layers (S1) are each attached at a side of the molding that is opposite the respective other side of the molding.

In one embodiment of the panel according to the invention the layer (S1) comprises at least one resin, the resin preferably being a reactive thermosetting or thermoplastic resin, the resin more preferably being based on epoxides, acrylates, polyurethanes, polyamides, polyesters, unsaturated polyesters, vinyl esters or mixtures thereof, the resin in particular being an amine-curing epoxy resin, a latent-curing epoxy resin, an anhydride-curing epoxy resin or a polyurethane composed of isocyanates and polyols. Such resin systems are known to those skilled in the art, for example from Penczek et al. (Advances in Polymer Science, 184, pages 1-95, 2005), Pham et al. (Ullmann's Encyclopedia of Industrial Chemistry, Vol. 13, 2012), Fahnler (Polyamide, Kunststoff Handbuch 3/4, 1998) and Younes (WO12134878 A2).

Preference is also given in accordance with the invention to a panel in which
i) the fiber region (FB1) of the fiber (F) is in partial or complete, preferably complete, contact with the first layer (S1), and/or
ii) the fiber region (FB3) of the fiber (F) is in partial or complete, preferably complete, contact with the second layer (S1), and/or
iii) the panel comprises between at least one side of the molding and at least one layer (S1) at least one layer (S2), wherein the layer (S2) is preferably composed of sheetlike fiber materials or polymeric films, more preferably of porous sheetlike fiber materials or porous polymeric films, especially preferably of paper, glass fibers or carbon fibers in the form of nonwovens, non-crimp fabrics or wovens.

Porosity is to be understood as meaning the ratio (dimensionless) of cavity volume (pore volume) to the total volume of a reactive foam. It is determined for example by image analytical evaluation of micrographs by dividing the cavity/pore volume by the total volume.

The overall porosity of a substance is made up of the sum of the cavities in communication with one another and with the environment (open porosity) and the cavities not in communication with one another (closed porosity). Preference is given to layers (S2) having a high open porosity.

In a further inventive embodiment of the panel the at least one layer (S1) additionally comprises at least one fibrous material, wherein
i) the fibrous material comprises fibers in the form of one or more plies of chopped fibers, nonwovens, non-crimp fabrics, knits and/or wovens, preferably in the form of non-crimp fabrics or wovens, particularly preferably in the form of non-crimp fabrics or wovens having a basis weight per non-crimp fabric/woven of 150 to 2500 g/m², and/or
ii) the fibrous material comprises fibers of organic, inorganic, metallic or ceramic fibers, preferably polymeric fibers, basalt fibers, glass fibers, carbon fibers or natural fibers, particularly preferably glass fibers or carbon fibers.

The elucidations described above apply to the natural fibers and the polymeric fibers.

A layer (S1) additionally comprising at least one fibrous material is also referred to as a fiber-reinforced layer, in particular as a fiber-reinforced resin layer provided that the layer (S1) comprises a resin.

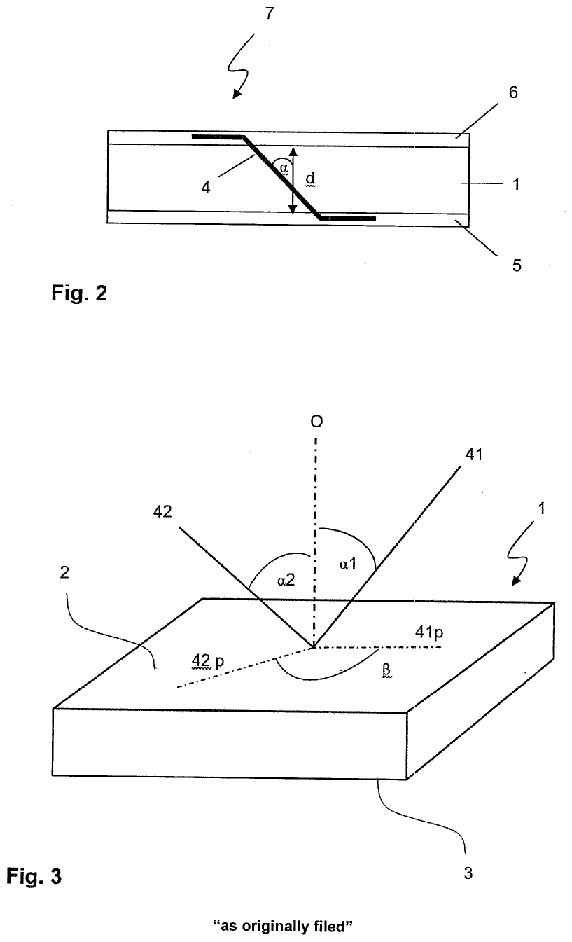

FIG. 2 shows a further preferred embodiment of the present invention. Shown in a two-dimensional side view is a panel (7) according to the invention which comprises a molding (1) according to the invention as detailed hereinabove in the context of the embodiment of FIG. 1 for example. Unless otherwise stated the reference numerals and other abbreviations in FIGS. 1 and 2 have the same meanings.

In the embodiment according to FIG. 2, the panel according to the invention comprises two layers (S1) represented by (5) and (6). The two layers (5) and (6) are thus each on mutually opposite sides of the molding (1). The two layers (5) and (6) are preferably resin layers or fiber-reinforced resin layers. As is further apparent from FIG. 2, the two ends of the fiber (4) are surrounded by the respective layers (5) and (6).

One or more further layers may also optionally be present between the molding (1) and the first layer (5) and/or between the molding (1) and the second layer (6). As described hereinabove for FIG. 1, for simplicity FIG. 2 also shows a single fiber (F) represented by (4). With regard to the number of fibers or fiber bundles in practice, that which is recited above for FIG. 1 applies analogously.

Also preferred is a panel where at least one of the following alternatives is fulfilled:
i) the molding present in the panel comprises at least one side that has not been subjected to mechanical and/or thermal processing, and/or
ii) the foam of the molding has a resin absorption of less than 1000 g/m², preferably of less than 500 g/m² and particularly preferably of less than 100 g/m², and/or
iii) the panel has a peel strength of more than 200 J/m², preferably of more than 500 J/m², particularly preferably of more than 2000 J/m², and/or
iv) the foam of the molding present in the panel has a specific shear strength in the range from 2 to 25 kPa/(kg/m³), preferably in the range from 3 to 15 kPa/(kg/m³), particularly preferably in the range from 4 to 12 kPa/(kg/m³), and/or
v) the foam of the molding present in the panel has a shear modulus measured parallel to the at least one layer (S1) in the range from 0.05 to 0.6 MPa/(kg/m³), preferably in the range from 0.05 to 0.5 MPa/(kg/m³), particularly preferably in the range from 0.05 to 0.2 MPa/(kg/m³), and/or
vi) the molding present in the panel has in the panel a specific shear strength measured parallel to the at least one layer (S1) of at least 5 kPa/(kg/m³), preferably of at least 8 kPa/(kg/m³), particularly preferably of at least 12 kPa/(kg/m³), and/or
vii) the molding present in the panel has in the panel a shear modulus measured parallel to the at least one layer (S1) of at least 0.2 MPa/(kg/m³), preferably of at least 0.6 MPa/(kg/m³), particularly preferably of at least 1.0 MPa/(kg/m³).

The specific shear strength and the shear modulus are determined according to DIN 53294 (1982 version) and the density according to ISO 845 (2007 version).

The peel strength of the panel is determined with single cantilever beam (SCB) samples. The thickness of the moldings is 20 mm and the layers (S1) are composed of quasi-isotropic glass fiber-reinforced epoxy resin layers in each case of about 2 mm in thickness. The panels are then tested in a Zwick Z050 tensile tester at a speed of 5 mm/min, the panel being loaded and unloaded three to four times. Crack propagation/growth is determined by visual assessment for each load cycle (Δa). The force-distance plot is used to ascertain the crack propagation energy (ΔU). This is used to ascertain the crack resistance or peel strength as

$${G}_{IC} = \frac{Δ U}{B Δ a}$$

where B is sample width.

Resin absorption is determined using not only the employed resin systems, the foam and glass non-crimp fabrics but also the following auxiliary materials: nylon vacuum film, vacuum sealing tape, nylon flow aid, polyolefin separation film, polyester tearoff fabric and PTFE membrane film and polyester absorption fleece. Panels, also referred to hereinafter as sandwich materials, are produced from the moldings by applying fiber-reinforced outer plies by means of vacuum infusion. Applied to each of the top side and the bottom side of the (fiber-reinforced) foams are two plies of Quadrax glass non-crimp fabric (roving: E-Glass SE1500, OCV; textile: saertex, isotropic laminate [0°/−45°/90° 45° ] of 1200 g/m² in each case). For the determination of the resin absorption, a separation film is inserted between the molding, also referred to hereinafter as core material, and the glass non-crimp fabric, in contrast with the standard production of the panels. The resin absorption of the pure molding is thus determinable. The tearoff fabric and the flow aids are attached on either side of the glass non-crimp fabrics. The construction is subsequently equipped with gates for the resin system and gates for the evacuation. Finally, a vacuum film is applied over the entire construction and sealed with sealing tape, and the entire construction is evacuated. The construction is prepared on an electrically heatable table having a glass surface.

The resin system used is amine-curing epoxy (resin: BASF Baxxores 5400, curing agent: BASF Baxxodur 5440, mixing ratio and further processing as per data sheet). After the mixing of the two components the resin is evacuated at down to 20 mbar for 10 minutes. Infusion onto the pre-temperature-controlled construction is effected at a resin temperature of 23+/−2° C. (table temperature: 35° C.). A subsequent temperature ramp of 0.3 K/min from 35° C. to 75° C. and isothermal curing at 75° C. for 6 h allows production of panels consisting of the reactive foams and glass fiber-reinforced outer plies.

Initially the moldings are analyzed according to ISO 845 (October 2009 version) to obtain the apparent density of the foam. After curing of the resin system the processed panels are trimmed in order to eliminate excess resin accumulations in the edge regions as a result of imperfectly fitting vacuum film.

The outer plies are then removed and the moldings present are reanalyzed by ISO 845. The difference in the densities gives the absolute resin absorption. Multiplication by the thickness of the molding gives the corresponding resin absorption in kg/m².

The present invention further provides a process for producing the molding according to the invention, wherein at least one fiber (F) is partially introduced into the foam with the result that the fiber (F) is with the fiber region (FB2) located inside the molding and surrounded by the foam while the fiber region (FB1) of the fiber (F) projects from a first side of the molding and the fiber region (FB3) of the fiber (F) projects from a second side of the molding.

Suitable methods of introducing the fiber (F) and/or a fiber bundle are in principle all those known to those skilled in the art. Suitable processes are described, for example, in WO 2006/125561 or in WO 2011/012587.

In one embodiment of the process according to the invention the partial introduction of the at least one fiber (F) into the foam is effected by sewing-in using a needle, the partial introduction preferably being effected by steps a) to f):
a) optionally applying at least one layer (S2) to at least one side of the foam,
b) producing one hole per fiber (F) in the foam and optionally in the layer (S2), wherein the hole extends from a first side to a second side of the foam and optionally through the layer (S2),
c) providing at least one fiber (F) on the second side of the foam,
d) passing a needle from the first side of the foam through the hole to the second side of the foam and optionally passing the needle through the layer (S2),
e) securing at least one fiber (F) to the needle on the second side of the foam, and
f) returning the needle along with the fiber (F) through the hole, so that the fiber (F) is with the fiber region (FB2) located inside the molding and surrounded by the foam while the fiber region (FB1) of the fiber (F) projects from a first side of the molding or optionally from the layer (S2) and the fiber region (FB3) of the fiber (F) projects from a second side of the molding,
   simultaneous performance of steps b) and d) being particularly preferred.

In a particularly preferred embodiment steps b) and d) are performed simultaneously. In this embodiment, the hole from the first side to the second side of the foam is produced by passing a needle from the first side of the foam to the second side of the foam.

In this embodiment the introduction of the at least one fiber (F) may comprise for example the following steps:
a) optionally applying a layer (S2) to at least one side of the foam,
b) providing at least one fiber (F) on the second side of the foam,
c) producing one hole per fiber (F) in the foam and optionally in the layer (S2), wherein the hole extends from the first side to a second side of the foam and optionally through the layer (S2) and wherein the hole is produced by passing a needle through the foam and optionally through the layer (S2),
d) securing at least one fiber (F) to the needle on the second side of the foam,
e) returning the needle along with the fiber (F) through the hole, so that the fiber (F) is with the fiber region (FB2) located inside the molding and surrounded by the foam while the fiber region (FB1) of the fiber (F) projects from a first side of the molding or optionally from the layer (S2) and the fiber region (FB3) projects from a second side of the molding,
f) optionally cutting off the fiber (F) on the second side and
g) optionally cutting open the loop of the fiber (F) formed at the needle.

In a preferred embodiment, the needle used is a hook needle and at least one fiber (F) is hooked in in the hook needle in step d).

In a further preferred embodiment a plurality of fibers (F) are introduced into the foam according to the above-described steps simultaneously.

In the process according to the invention it is additionally preferable when depressions in the molding are introduced into the foam partially or completely before the introduction of at least one fiber (F).

The present invention further provides a process for producing the panel according to the invention in which the at least one layer (S1) is produced, applied and cured on a molding according to the invention in the form of a reactive viscous resin, preferably by liquid impregnation methods, particularly preferably by pressure- or vacuum-assisted impregnation methods, especially preferably by vacuum infusion or pressure-assisted injection methods, most preferably by vacuum infusion. Liquid impregnation methods are known per se to those skilled in the art and are described in detail, for example, in Wiley Encyclopedia of Composites (2nd Edition, Wiley, 2012), Parnas et al. (Liquid Composite Moulding, Hanser, 2000) and Williams et al. (Composites Part A, 27, p. 517-524, 1997).

Various auxiliary materials can be used for producing the panel according to the invention. Suitable auxiliary materials for production by vacuum infusion include, for example, vacuum film, preferably made of nylon, vacuum sealing tape, flow aid, preferably made of nylon, separation film, preferably made of polyolefin, tearoff fabric, preferably made of polyester, and a semipermeable film, preferably a membrane film, particularly preferably a PTFE membrane film, and absorption fleece, preferably made of polyester. The choice of suitable auxiliary materials is guided by the component to be manufactured, the process chosen and the materials used, specifically the resin system. When employing resin systems based on epoxide and polyurethane it is preferable to use flow aids made of nylon, separation films made of polyolefin, tearoff fabric made of polyester and a semipermeable films as PTFE membrane films and absorption fleeces made of polyester.

These auxiliary materials can be used in various ways in the processes for producing the panel according to the invention. It is particularly preferable when panels are produced from the moldings by applying fiber-reinforced outer plies by means of vacuum infusion. In a typical construction, to produce the panel according to the invention, fibrous materials and optionally further layers are applied to the top side and the bottom side of the moldings.

Subsequently, tearoff fabric and separation films are positioned. The infusion of the liquid resin system may be carried out using flow aids and/or membrane films. Particular preference is given to the following variants:
i) use of a flow aid on just one side of the construction, and/or
ii) use of a flow aid on both sides of the construction, and/or
iii) construction with a semipermeable membrane (VAP construction); the latter is preferably draped over the full area of the molding, on which flow aids, separation film and tearoff fabric are used on one or both sides, and the semipermeable membrane is sealed with respect to the mold surface by means of vacuum sealing tape, the absorption fleece is inserted on the side of the semipermeable membrane remote from the molding, as a result of which the air is evacuated upward over the full area, and/or
iv) use of a vacuum pocket made of membrane film, which is preferably positioned at the opposite gate side of the molding, by means of which the air is evacuated from the opposite side to the gate.

The construction is subsequently equipped with gates for the resin system and gates for the evacuation. Finally, a vacuum film is applied over the entire construction and sealed with sealing tape, and the entire construction is evacuated. After the infusion of the resin system, the reaction of the resin system takes place with maintenance of the vacuum.

The present invention also provides for the use of the molding of the invention or of the panel of the invention for rotor blades, in wind turbines, in the transport sector, in the construction sector, in automobile construction, in shipbuilding, in rail vehicle construction, for container construction, for sanitary installations and/or in aerospace.

The present invention is more particularly elucidated hereinbelow with reference to examples.

### EXAMPLES

### Production of the Foams:

The inventive foam was produced by a continuous double belt foaming process. The plant consists of an upper conveyor belt and a lower conveyor belt. The reactive mixture (rM) was continuously injected between a lower carrier material and an upper carrier material via a high-pressure mixing head. The lower carrier material consisted of an aluminum foil and the upper carrier material likewise consisted of an aluminum foil. The reactive mixture (rM) was subsequently expanded and calibrated between the lower conveyor belt and the upper conveyor belt. The obtained foam was cut into sheets. The sheet thickness was 50 mm. The takeoff rate of the belt was 4.5 m/m in at a discharge rate of 18.1 kg/min. Before further tests and reinforcement with the at least one fiber (F) and thus before production of the molding the upper carrier material and the lower carrier material were taken off and the sheets were planed down to 20 mm for further processing.

The composition of the reactive mixture (rM) of the comparative example V2 and of the inventive example B1 are reported in table 1 as well as the molecular weight of the polyol component (component A)) and the proportion of the prepolymer in the isocyanate component (component B)).

TABLE 1

| | Example B1 | | | | Comparative example V2 | | | |
|---|---|---|---|---|---|---|---|---|
| | | Parts | M_{w} | | | Parts | M_{w} | |
| Component | | by wt. | [g/mol] | Functionality | | by wt. | [g/mol] | Functionality |
| A | polyol 1 | 20 | 4350 | 3 | polyol 4 | 56.5 | 500 | 4.3 |
| | polyol 2 | 30 | 530 | 3.8 | polyol 5 | 20 | 400 | 3 |
| | polyol 3 | 37 | 545 | 3.9 | polyol 6 | 6 | 300 | 4 |
| | glycerol | 5 | 92 | 3 | | | | |
| B | water | 1.3 | | | water | 1.9 | | |
| | pentane | 14 | | | pentane | 7.5 | | |
| C | pMDI | 32 | | | pMDI | 150 | | |
| | prepolymer | 128 | | | | | | |
| D | cat 1 | 0.5 | | | cat 1 | 0.5 | | |
| | cat 2 | 0.5 | | | | | | |
| | cat 3 | 3 | | | cat 3 | 3.8 | | |
| E | stabilizer | 2 | | | stabilizer | 2 | | |
| | dipropylene | 5 | 134 | 2 | TCPP | 15 | | |
| | glycol | | | | | | | |

Cat 1: s-triazine
Cat 2: bis(2-dimethylaminoethyl) ether
Cat 3: N,N-dimethylcyclohexylamine
Stabilizer: Tegostab B 8495 from Evonik
Prepolymer: prepolymer of 4,4′ mMDI, dipropylene glycol and polypropylene glycol having an NCO content of 22.9% and an average functionality of 2.2
pMDI: mixture of 1,4′-diphenylmethane diisocyanate with higher-functional oligomers and isomers (crude MDI) having an NCO content of 31.5% and an average functionality of about 2.7
TCPP: tris-2-chloroisopropyl phosphate

The properties of the foams are determined as follows:
Density: The density of the pure foams is determined according to ISO 845 (October 2009 version).
Closed-cell content is determined according to DIN EN ISO 4590:2003.
Notched impact strength is determined according to EN ISO 13802:2006.
Shrinkage is emulated close to production using a vacuum infusion setup. Before commencement of the test the sample (dimensions 150×150×20 mm³) is clearly marked on the surface at 48 measuring points in a grid of 2 cm with an edge clearance of 1 cm. The thickness is measured at the labelled points with an accuracy of ≤0.05 mm, and length and width are measured once to s 1 mm and the weight once to ≤0.1 g. An average is then formed from the thickness measurement. The test setup is effected on a metal plate. Directly below and above the foam/molding a ply of polyester tearoff fabric is applied to ensure uniform distribution of the vacuum pressure. The nylon vacuum film is secured to the metal plate with vacuum sealing tape; connection of the vacuum is effected next to the foam/molding to be tested but directly on the tearoff fabric. Serving as the connection is a PE or PTFE hose on which a nylon, PE or PTFE spiral hose is mounted. The test setup is subsequently placed in a heating cabinet at 120° C. for 4 hours under permanent vacuum. After cooling of the sample the thickness is remeasured at the 48 marked measuring points, the average is formed and compared with the average before the test. The deviation is defined by

$${ɛ}_{t} = \frac{\overline{{t}_{1}} - \overline{{t}_{2}}}{\overline{{t}_{1}}}$$

where εₜ is shrinkage in the thickness direction, t̅₁̅ is the average of the thickness
before the test and t̅₂̅ is the average of the thickness after the test.
Abrasion is carried out on a pneumatically powered linear drive at a defined speed of 0.2 m/s and a defined pressing force of 10 N for 50 cycles for the inventive foam while only 25 cycles were used for the comparative example on account of the great abrasion. Material removal in mm/as a percentage of the initial thickness is measured. The distance covered per abrasion cycle is 100 mm. The test temperature was 23° C. The material removal of the foam to be tested is determined with respect to a steel sheet having a defined roughness Rz=127 μm and also by abrasion against a sheet of the same foam. In both methods only the material removal from the test object and not that from any counterpart (metal sheet, foam sheet) is measured. In order to allow the influence of any anisotropic alignment of the cells to feed into the measurement the film is rotated by 90° in the plane with respect to the steel sheet and also in the abrasion test with respect to itself. Thus four combinations are measured per example.

The roughness R_{z} is the average roughness depth, i.e. the arithmetic mean of the individual roughness depths of five adjacent individual measurement sectors. The individual roughness depth Zᵢ is the distance between two parallels to the average line which within the individual measurement sector touch the roughness profile at the highest and at the lowest point. X describes the extrusion direction in continuous production processes and the block direction having the longer axis in discontinuous processes. By contrast, Y describes the direction transverse to the extrusion direction in continuous production processes and the block direction transverse to the X axis in discontinuous processes. Z is in both processes defined as the rise direction (thickness) of the foam during the process.
Chemical stability is determined qualitatively in a two-stage process. Initially, a block of the foam having edge lengths of 50×10×5 mm³ is in a test tube half-immersed (25 mm) in the resin and also in the curing agent to be used and left therein for 4 h at 23° C. It is subsequently qualitatively evaluated whether the foam has undergone partial or complete dissolution or whether it was resistant. The second stage is an infusion test of the foam with subsequent curing according to manufacturer's instructions. This test may be combined with the resin absorption test and can thus generate a partly quantitative result.
Resin absorption: For resin absorption, foams are compared after material has been removed from the surface by planing. As well as the resin systems used, the foam slabs and glass non-crimp fabrics, the following auxiliary materials are used: nylon vacuum film, vacuum sealing tape, nylon flow aid, polyolefin separation film, polyester tearoff fabric and PTFE membrane film and polyester absorption fleece. Panels are produced from the moldings by applying fiber-reinforced outer plies by means of vacuum infusion. Applied to each of the top side and the bottom side of the foams are two plies of Quadrax glass non-crimp fabric (roving: E-Glass SE1500, OCV; textile: saertex, isotropic laminate [0°/−45°/90° 45° ] of 1200 g/m² in each case). For the determination of the resin absorption, a separation film is inserted between the foam and the glass non-crimp fabric, in contrast with the standard production of the panels. In this way, the resin absorption of the pure foam is determinable. The tearoff fabric and the flow aids are attached on either side of the glass non-crimp fabrics. The construction is subsequently equipped with gates for the resin system and gates for the evacuation. Finally, a vacuum film is applied over the entire construction and sealed with sealing tape, and the entire construction is evacuated. The construction is prepared on an electrically heatable table having a glass surface.

The resin system used is amine-curing epoxy (resin: BASF Baxxores 5400, curing agent: BASF Baxxodur 5440, mixing ratio and further processing as per data sheet). After the mixing of the two components the resin is evacuated at down to 20 mbar for 10 minutes. Infusion onto the pre-temperature-controlled construction is effected at a resin temperature of 23+/−2° C. (table temperature: 35° C.). By means of a subsequent temperature ramp of 0.3 K/min from 35° C. to 75° C. and isothermal curing at 75° C. for 6 h, it is possible to produce panels consisting of the moldings and glass fiber-reinforced outer plies.

At the start, the foams are analyzed according to ISO 845 (October 2009 version), in order to obtain the apparent density of the foam. After curing of the resin system the processed panels are trimmed in order to eliminate excess resin accumulations in the edge regions as a result of imperfectly fitting vacuum film. Subsequently, the outer plies are removed and the foams present are analyzed again by ISO 845. The difference in the densities gives the absolute resin absorption. Multiplication by the thickness of the foam gives the corresponding resin absorption in kg/m².

The resin absorption tests for the reinforced structure were performed analogously. The amount of resin absorbed by the fibers in the foam was determined qualitatively. To this end the thickness and regularity of impregnated previously introduced rovings (E-Glass, OCV, 400 tex) were evaluated.
The pull out resistance/the required force was qualitatively determined by hand by a pullout test of introduced fibers. The rovings (E-glass, OCV, 400 tex) were introduced into the foam orthogonally to the surface by hand with a needle according to EP 1883526. After introduction of the roving via the roving loop the roving was pulled out of the foam manually. The required force was determined qualitatively.
   The results of the tests are reported in table

TABLE 2

| | | | Comparative |
|---|---|---|---|
| Test | Unit | Example B1 | example V2 |
| Density (ISO 845) | [kg/m³] | 45 | 45 |
| Closed-cell content | [%] | + | + |
| (ISO 4590) | | | |
| Shrinkage (120° C., | [%] | 3 | 3 |
| 4 h, 0 mbar) | | | |
| Notched impact | [J] | ++ | 0 |
| strength | | | |
| Abrasion against | [mm] | 1.75 | 2.57 |
| itself X - X | | | |
| Abrasion against | [%] | 9 | 13 |
| itself X - X | | | |
| Abrasion against | [mm] | 1.74 | 3.31 |
| itself X - Y | | | |
| Abrasion against | [%] | 9 | 16 |
| itself X - Y | | | |
| Abrasion with respect | [mm] | 4.17 | 6.49 |
| to steel sheet having | | | |
| Rz = 127 μm | | | |
| (steel - X) | | | |
| Abrasion with respect | [%] | 21 | 32 |
| to steel sheet having | | | |
| Rz = 127 μm | | | |
| (steel - X) | | | |
| Abrasion with respect | [mm] | 3.91 | 5.94 |
| to steel sheet having | | | |
| Rz = 127 μm | | | |
| (steel - Y) | | | |
| Abrasion with respect | [%] | 19 | 29 |
| to steel sheet having | | | |
| Rz = 127 μm | | | |
| (steel - Y) | | | |
| Chemical stability | [—] | Withstands infusion | Withstands |
| | | process | infusion process |
| General resin | [g/m²] | 250 | 390 |
| absorption | | | |
| Resin absorption with | [g/m²] | low | moderate |
| reinforcing structure | | | |
| Pullout resistance | [N] | high | moderate |

The advantages of the inventive foam are apparent from the measured data. The abrasion resistance is markedly increased, thus reducing emission and improving transportability/handling. In addition the foam with reinforcing structures exhibits lower resin absorptions (less weight for same performance) and higher pullout resistances (important for handling and for converting steps).

1.-15. (canceled)

16. A molding made of foam, wherein at least one fiber (F) is with a fiber region (FB2) located inside the molding and surrounded by the foam while a fiber region (FB1) of the fiber (F) projects from a first side of the molding and a fiber region (FB3) of the fiber (F) projects from a second side of the molding, wherein the foam has been produced by polymerization of a reactive mixture (rM) which comprises the following components (A) to (C):
(A) at least one compound having isocyanate-reactive groups, wherein at least one compound having isocyanate-reactive groups has a weight-average molecular weight of at least 1700 g/mol,
(B) at least one blowing agent and
(C) at least one polyisocyanate which comprises 14% to 100% by weight based on the total weight of the at least one polyisocyanate of at least one polyisocyanate prepolymer,
wherein the reactive mixture (rM) comprises no further polyisocyanate other than component (C), wherein the component (A) is produced from a compound selected from the group consisting of alcohols, saccharides, sugar alcohols and amines and the component (B) of the reactive mixture (rM) is selected from the group consisting of n-pentane, isopentane, cyclopentane, 1,1,1,3,3-pentafluorobutane, 1,1,1,3,3-pentafluoropropane, 1,1,1,2,3,3,3-heptafluoropropane, water and hydrofluoroolefins and the component (C) has an isocyanate index in the range from 90 to 180.

17. The molding according to claim 16, wherein the component (C) has an isocyanate index in the range from 80 to 150.

18. The molding according to claim 16, wherein
i) the surface of at least one side of the molding has at least one depression, the depression being a slot or a hole, and/or
ii) the total surface area of the molding is closed to an extent of more than 30%, and/or
iii) the foam has a glass transition temperature of at least 80° C.

19. The molding according to claim 16, wherein
i) the fiber (F) is a single fiber or a fiber bundle, and/or
ii) the fiber (F) is an organic, inorganic, metallic or ceramic fiber or a combination thereof, and/or
iii) the fiber (F) is employed in the form of a fiber bundle having a number of individual fibers per bundle of at least 10 in the case of glass fibers and 1000 to 50 000 in the case of carbon fibers, and/or
iv) the fiber region (FB1) and the fiber region (FB3) each independently of one another account for 1% to 45% and the fiber region (FB2) accounts for 10% to 98% of the total length of a fiber (F), and/or
v) the fiber (F) has been introduced into the foam at an angle α of 0° to 60 or of 10 to 70°, relative to the thickness direction (d) of the molding, and/or
vi) in the molding the first side of the molding from which the fiber region (FB1) of the fiber (F) projects is opposite the second side of the molding from which the fiber region (FB3) of the fiber (F) projects, and/or
vii) the molding comprises a multitude of fibers (F) and/or comprises more than 10 fibers (F) or fiber bundles per m².

20. A panel comprising at least one molding according to claim 16 and at least one layer (S1).

21. The panel according to claim 20, wherein the layer (S1) comprises at least one resin.

22. The panel according to claim 21, wherein the layer (S1) additionally comprises at least one fibrous material, wherein
i) the fibrous material comprises fibers in the form of one or more plies of chopped fibers, nonwovens, non-crimp fabrics, knits and/or wovens, and/or
ii) the fibrous material comprises organic, inorganic, metallic or ceramic fibers.

23. The panel according to claim 20, wherein the panel comprises two layers (S1) and the two layers (S1) are each attached at a side of the molding that is opposite the respective other side of the molding.

24. The panel according to claim 20, wherein
i) the fiber region (FB1) of the fiber (F) is in partial or complete contact with the first layer (S1), and/or
ii) the fiber region (FB3) of the fiber (F) is in partial or complete contact with the second layer (S1), and/or
iii) the panel comprises between at least one side of the molding and at least one layer (S1) at least one layer (S2), wherein the layer (S2) is composed of sheetlike fiber materials or polymeric films.

25. The panel according to claim 20, wherein the molding present in the panel comprises at least one side that has not been subjected to mechanical and/or thermal processing.

26. A process for producing a molding according to claim 16, wherein at least one fiber (F) is partially introduced into the foam with the result that the fiber (F) is with the fiber region (FB2) located inside the molding and surrounded by the foam while the fiber region (FB1) of the fiber (F) projects from a first side of the molding and the fiber region (FB3) of the fiber (F) projects from a second side of the molding.

27. The process according to claim 26, wherein the partial introduction of at least one fiber (F) into the foam is effected by sewing-in using a needle,
the partial introduction being effected by steps a) to e):
a) optionally applying at least one layer (S2) to at least one side of the foam,
b) producing one hole per fiber (F) in the foam and optionally in the layer (S2), wherein the hole extends from a first side to a second side of the foam and optionally through the layer (S2),
c) providing at least one fiber (F) on the second side of the foam,
d) passing a needle from the first side of the foam through the hole to the second side of the foam and optionally passing the needle through the layer (S2),
e) securing at least one fiber (F) on the needle on the second side of the foam, and
f) returning the needle along with the fiber (F) through the hole, so that the fiber (F) is with the fiber region (FB2) located inside the molding and surrounded by the foam while the fiber region (FB1) of the fiber (F) projects from a first side of the molding or optionally from the layer (S2) and the fiber region (FB3) of the fiber (F) projects from a second side of the molding,
optionally performing steps b) and d) simultaneously.

28. The process according to claim 26, wherein the depressions in the molding are introduced into the foam partially or completely before the introduction of at least one fiber (F).

29. A process for producing a panel according to claim 20, wherein the at least one layer (S1) is produced, applied and cured on the molding in the form of a reactive viscous resin, by liquid impregnation methods.

30. A rotor blade for a wind turbine comprising the molding according to claim 16.
